(19) United States
(12) Patent Application Publication
(10) Pub. No.: US 2024/0302285 A1
(43) Pub. Date: Sep. 12, 2024

(54) SERS SUBSTRATE COMPRISING NANOPARTICLES

(71) Applicant: PHORNANO HOLDING GMBH, Korneuburg (AT)

(72) Inventors: Andreas STINGL, Korneuburg (AT); Olavo Dhyan DE FARIAS CARDOZO, Recife (BR)

(21) Appl. No.: 18/573,146

(22) PCT Filed: Jun. 24, 2022
(86) PCT No.: PCT/AT2022/060217

§ 371 Date: Dec. 21, 2023

(30) Foreign Application Priority Data
Jun. 25, 2021 (AT) A 50526/2021

(51) Int. Cl. G01N 21/65; B82Y 20/00

(52) U.S. Cl. CPC G01N 21/658; B82Y 20/00

(57) ABSTRACT

A substrate suitable for SERS, including a metal body and located on a surface of the metal body a layer of nanoparticles, wherein the nanoparticles have an average diameter or size of 10 nm to 100 nm, and wherein the metal body has a thickness of at least 30 μm beneath the surface with the nanoparticles is disclosed.

The present invention relates to Surface Enhanced Raman Spectroscopy (SERS) substrates.

### BACKGROUND

Surface Enhanced Raman Spectroscopy (SERS) substrates for surface-enhanced Raman scattering significantly increase the sensitivity of Raman spectroscopy. This enables the smallest molecular traces to be detected in order to meet strict requirements in the (food) industry and in the healthcare sector and offers a fast, cost-effective and on-site alternative to chromatographic and laboratory-based detection techniques.

Most prominent types of SERS substrates are: Nanoparticle & Paper based substrates, drop cast or print (Wei W. Yu and Ian M. White, Anal Chem. 2010, 82 (23): 9626-9630, doi: 10.1021/ac102475k); nanoparticle & non-paper based, drop cast or print (Gudun et al. Hindawi Journal of Nanomaterials Volume 2017, Article ID 9182025, doi: 10.1155/2017/9182025); as well as Vacuum processed (Lithography or sputtering), in particular the Hamamatsu substrate (Liu et al. Plasmonics 15, 743-752 (2020), doi: 10.1007/s11468-019-01084-8).

CN 104949957 A describes a SERS substrate with a lattice of nanoparticles that are embedded in a nanostructured pit array.

US 2012/0242987 A1 describes a SERS active inner surface of a cylindrical container.

WO 2020/227450 A1 describes a SERS substrate with gaps based on tube shaped hollow nanostructures made by solar vapor generation.

CN 108823541 A describes a SERS substrate with inverted hollow silver nano-volcanic island structures on a porous anodized aluminum surface.

CN 106077697 A describes a method to generate a silver nanoflower cluster/silver microchip for SERS uses.

### SUMMARY OF THE INVENTION

It is a goal of the invention to provide SERS substrates that allow improved spectroscopic measurements and analyte detection parameters, in particular an increased sensitivity.

The invention provides a substrate comprising a metal body and located on a surface of said metal body a layer of nanoparticles, wherein the nanoparticles have an average diameter or size of 10 nm to 100 nm, and wherein the metal body has a thickness of at least 30 μm beneath said surface with the nanoparticles.

The invention further provides a method of manufacture of a substrate according to the invention, the method comprises depositing a suspension of nanoparticles in a dispersion medium on a surface of a metal body, with the metal body having a thickness of at least 30 μm beneath said surface, wherein said suspension is deposited in amounts comprising 100 Million (Mio) nanoparticles/mm² to 100 000 Mio nanoparticles/mm² of the surface, and removing the dispersion medium with the nanoparticles remaining on the surface.

The invention further provides a method of spectroscopy comprising providing a substrate of the invention, depositing a sample with an analyte on the substrate's surface comprising the nanoparticles, irradiating the analyte on the substrate with light with a wavelength of 200 nm to 1200 nm, measuring a reflecting light from said analyte, preferably wherein said reflecting light is scattered light.

All aspects of the invention are related to each other and the following detailed disclosure of particular or preferred embodiments relates to all aspects, even when illustrated in connection with a specific aspect. E.g. any variant of the substrate can be produced by an inventive method of manufacture. Particular parameters of substrates can be selected or produced in the methods, e.g. by selecting suitable or adjusting materials. Any substrate can be used in the methods of spectroscopy and a description of the substrates also relates to these methods, and vice-versa, a substrate can be suitable for a particularly described method of spectroscopy.

### BRIEF DESCRIPTION OF THE DRAWINGS

FIG. 1: Setup of a SERS system including a Raman laser (Laser), a spectrometer (detector) and a SERS substrate, consisting of a layer formed by nanoparticles as well as a signal enhancing metal body underneath this layer.

FIG. 2: SERS substrate applying an incident laser beam (1), generating a Raman signal (2), loaded with the analyte sample, drop shape (3), consisting of a layer of nanoparticles (4) and a signal enhancing metal body (5).

FIG. 3: The area of the active nanoparticle coating equals the area of the signal enhancing heat sink. This method is favorable when the nanoparticle coating is applied in large surfaces and subsequently cut in individual SERS substrates.

FIG. 4: The area of the active nanoparticle coating is smaller than the area of the signal enhancing heat sink. This method allows to use a thinner signal enhancing heat sink (e.g.: an Al-foil), however, to economize nanoparticle coating, it requires a more complex process of applying the coating in a confined way.

FIG. 5: Comparison between the nanoparticle in suspension (dash-dotted) and two typical layers formed by the nanoparticles on the surface of the signal enhancing heat sink.

FIG. 6: The layer structure formed from single nanospheres contains single nanospheres but also aggregates forming nanorods of different sizes.

FIG. 7: Damage could not be observed, even at 100% power level of the Raman laser. The linear behavior indicates that the damage threshold has not yet been reached.

FIG. 8: Three measurements on different spots for the demonstration of reproducibility.

FIG. 9: A metal body (A) with a layer of nanoparticles (B) on a carrier (C) and a cover sheet (D) on top.

### DETAILED DISCLOSURE OF THE INVENTION

The invention provides a substrate comprising a metal body and located on a surface of said metal body a layer of nanoparticles. The nanoparticles have an average diameter or size of 10 nm to 100 nm. The metal body has a thickness of at least 30 μm beneath said surface with the nanoparticles, i.e. a thickness in the direction perpendicular to the surface.

“Metal body” refers to the metallic property or metallic aggregate state of the body. Metals have a high thermal conductivity, which in connection with the inventive minimum thickness of the substrate leads to efficient temperature regulation of the substrate surface—and any analytes or media that are deposited thereon for a spectroscopic measurement.

The invention provides substrates suitable for Surface Enhanced Raman Spectroscopy (SERS) with nanoparticles (such as gold or silver nanoparticles, abbreviated AuNP or AgNPs, respectively) attached to a metal base body. In particular embodiments, the inventive SERS substrates obtained are homogeneous and demonstrate an extraordinarily high damage threshold of more than 3 kW/cm². They are suitable for Raman lasers of up to 300 mW-500 mW or even more in the VIS-NIR spectral range or even higher laser powers with larger metal body thickness and/or dimension in general.

Due to the metal's thermal conductivity, the metal body (also referred to as metal base) can therefore also be considered as a heat sink and is referred to as such herein.

Accepting higher laser power from increasingly more powerful, compact and affordable lasers available, means more signal and a lower limit of detection (LoD). On the other side, the risk of damaging the substrate as well as altering the analyte to be characterized due to high temperature increases.

With the objective to lower the LOD of the SERS technology to penetrate into markets which are currently only accessible for chromatographic and laboratory-based detection techniques, the use of attractive, diode based, cost effective and powerful lasers at, e.g. lasers with a wavelength of 785 nm, need to be matched with SERS substrates which can cope with the high laser power applied, without being damaged and protecting the analyte applied on the surface of the substrate to be altered due to excessive heat.

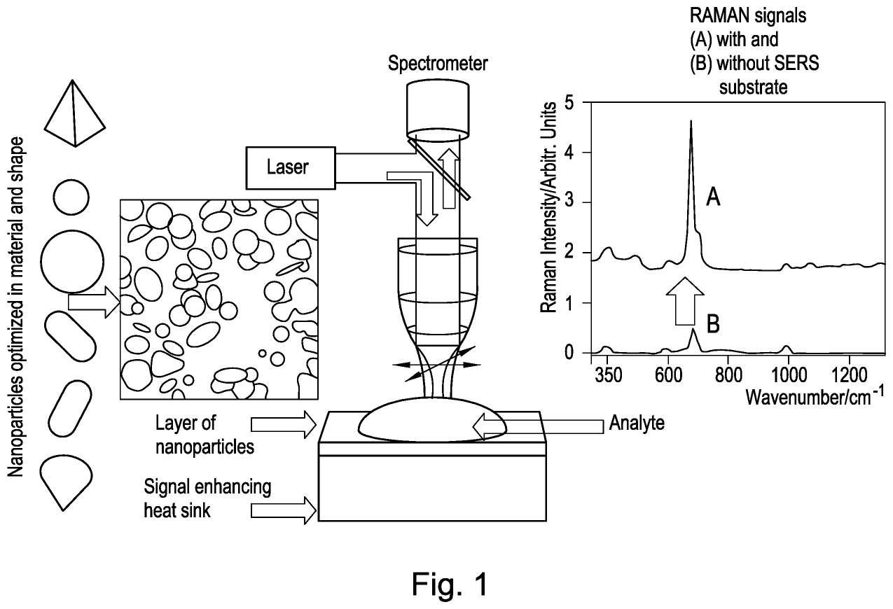

An amplification of a Raman signal occurs because of the enhancement of the electric field provided by the SERS substrate. When the incident light (usually laser light) strikes the active surface of the SERS substrate, localized surface plasmons are excited (FIG. 1). “Active surface” or “active area” refers to the part of the metal body's surface that is irradiated during spectroscopic measurements, or on the substrate, the area that is intended to be irradiated during such uses. It is the area of the surface that is covered by the nanoparticles. The side of the metal body facing the nanoparticles may be larger, i.e. only a part of this side of the metal body is coated with nanoparticles (FIG. 4), or the metal body may not extend beyond the nanoparticle-coated area on this side facing the nanoparticles (FIG. 3).

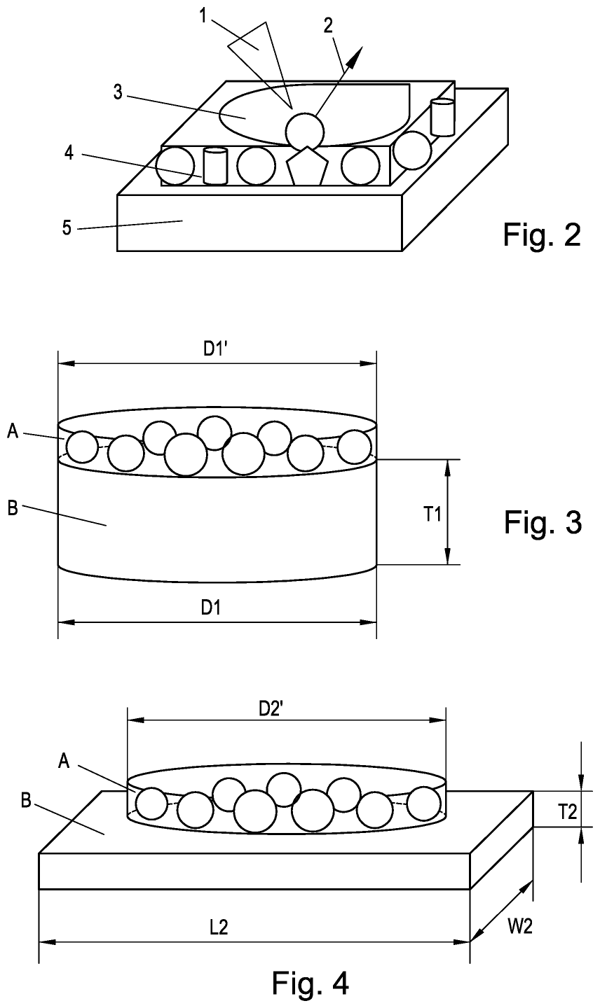

The nanoparticles employed are responsible for a resonant enhancement of the signal during Raman spectroscopy (SERS). The SERS effect is so pronounced because the field enhancement occurs twice. First, the resonant field enhancement amplifies the intensity of incident laser light, which excites the Raman modes of the molecules of the analyte. The resulting enhanced Raman signal is then further amplified by the SERS substrate due to the same resonant effect that amplifies the electric field of the incident laser light (FIG. 1 and FIG. 2).

The material of the metal body is a metal that enhances the Raman signal by either (i) interacting with the nanoparticles applied, and/or (ii) reflecting light and thereby increasing the incident beam from the Raman laser interacting with the nanoparticles (double pass) and/or (iii) reflecting and thereby amplifying the Raman signal. Those properties contribute to the signal enhancing feature.

The metal may offer (i) a good heat conductivity and (ii) good heat capacity due to its specific heat capacity and its mass. An example of such a material is a bulk aluminum or an Aluminum-sheet with a mass and specific heat capacity to prevent it from overheating during the exposure time of the Raman laser.

If the surface of the signal enhancing heat sink (metal body) is limited to the active area (FIG. 3), with the active area being in the range of e.g. 5 mm in diameter, the metal body's thickness should be 30 μm or more, typically 50 μm or more, depending on the intended laser power. This is significantly thicker than a common household or professional aluminum foil, which have a thickness of typically 18-25 μm. Preferably, the metal body has a thickness (dimension perpendicular to the surface with the nanoparticles) of 30 μm or more, 35 μm or more, 40 μm or more, 45 μm or more, 50 μm or more, 60 μm or more, 70 μm or more, 80 μm or more, 90 μm or more, 100 μm or more, 150 μm or more, 200 μm or more, 300 μm or more, 400 μm or more, 500 μm or more, 1 mm or more, or any range in between these values.

If the size of the signal enhancing heat sink may be larger than the active area (FIG. 4), a thinner metal body can be utilized, however, it needs to be taken care that the metal body is thick enough to allow the heat generated to be removed from the nanoparticles and the sample deposited thereon and again, its mass and specific heat capacity need to prevent the active area from overheating.

Further details on thermal capacity, thermal conductivity and dimensions of the metal body are provided in a separate chapter below.

In some embodiments the surface of the metal body comprises a metal oxide, preferably aluminium oxide. A metal oxide, in particular in a layer on the surface, may provide some separation of the metallic body and the nanoparticles and may help to improve the nanoparticle's plasmon resonance. In other embodiments, the nanoparticles are in contact with the metallic surface, e.g. without a or with a non-significant separating oxide layer.

Preferably, the surface is a substantially flat surface in a contiguous area of at least 1 mm² and/or lacks a nanostructured surface made of the body metal with a nanostructured surface being made by pits or peaks of a centre distance of at least 100 nm, preferably at least 80 nm, and with a depth or height respectively of at least 10 nm. The centre distance is the distance from the centre of a pit or peak to the centre of the next closest pit or peak, respectively. The centre is the centre of the area at the base of the pit or peak in the plane of the surface of the metal body (positioning centre on the surface). This surface property does not take account of the nanoparticles, which are of course a nanostructured material. However, the metal body itself is preferably smooth and with limited or no curvature to allow a strong mirror-like or regular reflection in one direction, i.e. a direction in which the reflecting light can be guided to a detector. Some curvature of the metal body is possible, if it does not impede optical measurements. Usually, curvatures with a radius of 1 mm or more are not problematic. Depending on the light (e.g. laser) spot size for the irradiation, the curvature can also be smaller. Eg. A light/laser spot size of 10 μm allows such limited curvatures as the surface of the metal body is sufficiently flat for small curvature radii in the mm range. In some embodiments the curvature radius may be at least 50×, preferably at least 100×, the thickness of the metal body. For example, the curvature radius can be at least 0.5 mm, preferably at least 1 mm, or more preferred at least 2 mm.

The nanoparticles may have various shapes or sizes in the manometer range. The shape may be isotropic or anisotropic shape, such as spherical, pyramidical, ellipsoidal, cylindrical etc. . . . The “size” or “diameter” of the nanoparticle refers to the dimension with the longest extension. The average size or diameter may be in the range of 10 nm to 100 nm, e.g. preferably 15 nm to 90 nm, 20 nm to 80 nm, 25 nm to 70 nm, 30 nm to 60 nm, 35 nm to 55 m, or even more preferred 40 nm to 50 nm. Preferably at least 50% or at least 75% of the nanoparticles have these sizes or diameters, e.g. 10 nm to 100 nm, e.g. preferably 15 nm to 90 nm, 20 nm to 80 nm, 25 nm to 70 nm, 30 nm to 60 nm, 35 nm to 55 m, or even more preferred 40 nm to 50 nm.

The nanoparticles can also be referred to as “manufactured nanomaterials”, which are artificial nanomaterials in the size range of 1 nm to 100 nm, which preferably have the above-mentioned shapes and/or sizes or diameters. As such the term “nanoparticle” can also be replaced by “manufactured nanomaterial” throughout this description. “Manufactured nanomaterials” are kept in suspension. Such suspensions can be applied to the surface of the metal body to deposit the nanomaterials or nanoparticles.

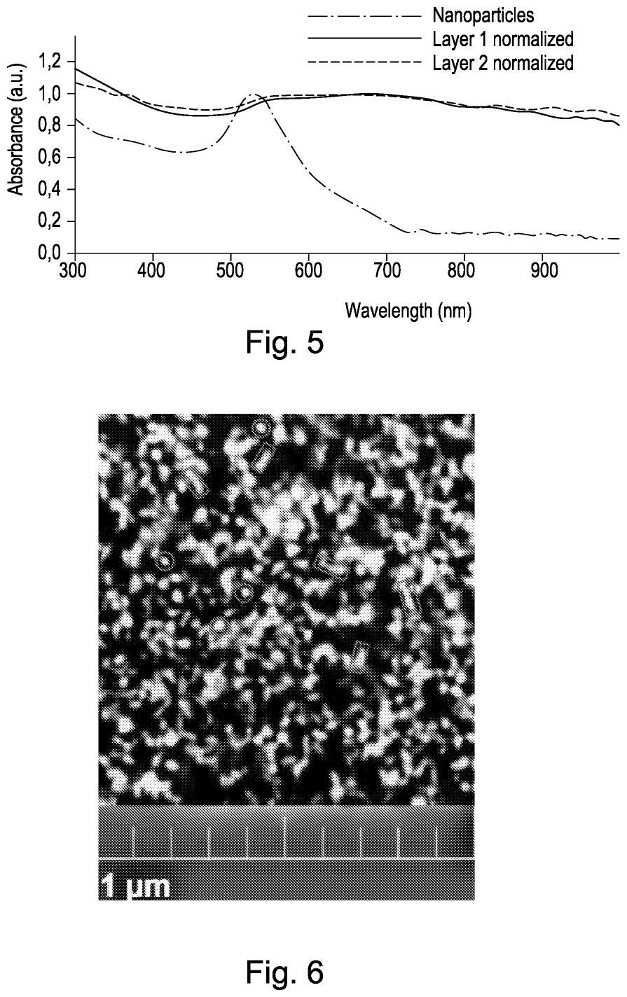

In particular preferred embodiments of all aspects and other embodiments of the invention, a portion of the nanoparticles are in contact with other nanoparticles, such as 0.01% or more or 0.1% or more of the nanoparticles, e.g. 0.1% to 30% of the nanoparticles. Such contacting nanoparticles may form nanoparticle aggregates or agglomerates, such as nanoparticle multimers and/or nanoparticle nanorods. Preferably, at least 0.01% or more, preferably 0.1% or more, of the nanoparticles form aggregates or agglomerates, such as nanoparticle multimers and/or nanorods. Some aggregates, agglomerates, multimers and/or nano-rods may have a size in their longest dimension (length, or diameter when of uniform shape) of at least 100 nm, preferably at least 120 nm or at least 150 nm. Preferably, at least 1% of the nanoparticle aggregates, agglomerates, multimers and/or nanoparticle nanorods have a size in their longest dimension (length, or diameter when of uniform shape) of at least 100 nm, e.g. 100 nm to 600 nm, preferably at least 120 nm. The nanoparticle aggregates, agglomerates, multimers and/or nanoparticle nanorods, at any of the above percentages or at an amount of at least 50% of the nanoparticles participating in nanoparticle aggregates, agglomerates, multimers and/or nanoparticle nanorods, may have a size of up to 600 nm, up to 500 nm, up to 400 nm, up to 300 nm, up to 200 nm. Such contacting nanoparticles, in particular the aggregates, agglomerates, multimers and nanorods widen the resonance spectrum and make the substrate reactive for a wider wavelength range (FIG. 5). E.g. the aggregation or agglomeration may enhance the spectral range of absorbance to the NIR spectral region (700 to >1000 nm). Preferably, at least 0.01%, more preferred at least 0.18, even more preferred at least 18, of the nanoparticles are in contact with other nanoparticles, preferably to form nanoparticle multimers and/or nanorods.

The nanoparticles can be of any known SERS active material known in the art. Preferably, the nanoparticles comprise or substantially consist of a noble metal, such as preferably gold or silver.

Preferably, the metal body comprises aluminium or copper. Aluminium is particularly preferred as it can enhance the Raman signal as it has a high reflectivity and beneficial effect of the nanoparticles. Enhancements of the Raman signal may be by (i) interacting with the nanoparticles applied, and/or (ii) reflecting and thereby amplifying the incident beam from the Raman laser through the nanoparticle layer (double pass) and/or (iii) reflecting and thereby amplifying the Raman signal. An example of such a material is an Aluminium-foil. Those properties contribute to the signal enhancing feature. Copper has similar advantages.

The nanoparticles are preferably deposited in an amount so that most are located at a distance from each other (inter-particle distance) of about 0 nm to 100 nm. This distance refers to the closest nanoparticle to a given nanoparticle. In particular, preferably at least 90% of the nanoparticles are located at inter-particle distances in the range of 0 nm to 100 nm. Even closer or denser, preferably at least 90% of the nanoparticles are at a distance of 0 nm to 60 nm.

The nanoparticles can form a layer of nanoparticles. This layer may have a particular thickness or thickness range such as a maximum thickness of 10 nanoparticles or 6 nanoparticles. The thickness may be variable since small spots on the metal body surface may be free of a nanoparticle, while others may have several nanoparticles on top of each other, in particular when the nanoparticles form aggregates. As such, preferably, the layer of nanoparticles has a thickness of 0 to 6 nanoparticles. This variable thickness may be at a surface of least 1 mm², or at least 2 mm², at least 3 mm², at least 5 mm² or more, on the metal body or on the so-called active area as mentioned above.

The nanoparticles or at least a majority of them should be Surface Enhanced Raman Spectroscopy (SERS) active, i.e. they provide a Raman signal enhancement in SERS in comparison to Raman spectroscopy without said nanoparticles (but otherwise identical spectroscopy). Such particles are known in the art, as e.g. discussed in the background section above.

Preferably, said surface of the metal body comprises 100 Mio nanoparticles/mm² to 100 000 Mio nanoparticles/mm², preferably 1 000 Mio nanoparticles/mm² to 10 000 Mio nanoparticles/mm², even more preferred 2 000 Mio nanoparticles/mm² to 3 000 Mio nanoparticles/mm², or even more nanoparticles. Higher amounts or densities of nanoparticles improve the SERS effect.

Preferably the surface with the nanoparticles has a reflectance of at least 50%, preferably at least 70%, at 785 nm when irradiated at a right angle to the surface and with the reflectance being at a right angle to the surface. A higher reflectance leads to a stronger signal as light is reflected back to the nanoparticles and can therefore pass the nanoparticles two times (as incoming light and then again as reflected light). This further improves the detection quality of any spectroscopic measurements. The reflectance can be improved by a smooth surface and by using a high reflecting material.

Smooth aluminium surfaces are a good option to this effect. For a good spectroscopic setup, the volume above the surface is unobstructed by any part of the substrate. E.g. the surface is not an inner surface of a tube and the like. The volume above the surface means that it is free to place spectroscopic devices there that can detect reflected and/or scattered light, in particular to detect a Raman signal, from the nanoparticles and/or any analyte deposited thereon. There should be a free volume e.g. up to the distance of 0.5 cm or even more above the surface with the nanoparticles.

The invention further provides a method of manufacture of a substrate, according to the invention comprising depositing a suspension of nanoparticles in a dispersion medium on a surface of a metal body, with the metal body having a thickness of at least 30 μm beneath said surface, wherein said suspension is deposited in amounts comprising 100 Million (Mio) nanoparticles/mm² to 100 000 Mio nanoparticles/mm² of the surface, and removing the dispersion medium with the nanoparticles remaining on the surface. Of course, any parameters and options as discussed above can also be applied to the method of manufacturing, such as, the metal body may have a higher thickness, there may be higher numbers of nanoparticles, the metal body may be of a material as discussed above etc. The dispersion medium may be any medium suitable for such a nanoparticle dispersion, such as water. The medium may have a stabilizer, such as citrate. The stabilizer may be on the surface or be removed, e.g. by washing. Such a method is basically a drop cast or drop print method, with the drop referring to the dispersion.

Preferably the suspension of nanoparticles is deposited onto the surface of the metal body in a vessel with side walls and/or with a height of the deposited suspension of at least 0.1 mm. The side walls allow deposition of larger amounts of the dispersion in one step to prevent overflow. The side walls may be connected to the metal body. One example is a metal cup with optionally the side walls being of the same material as the metal body. After depositing the nanoparticles, such side walls may be removed, e.g. the bottom of a cup may be cut out.

As mentioned above, the metal body may be larger in the dimension of the surface than the active area (FIG. 4) or not (FIG. 3). In case of the heat sink (metal body) being limited to the active area (having of course the thickness of any kind as mentioned above), the layer of nanoparticles may be applied via drop casting in a large area of e.g. several mm, cm or inches of diameter by evaporation of the dispersion medium. Individual active SERS elements can be obtained by cutting out the coated SERS substrates. In such a way, a homogeneous coating can be obtained and the entire coated area can be utilized (FIG. 3). The volume of the signal enhancing heat sink calculates to the area of the layer of nanoparticles (e.g.: (D1/2)²×JT times the thickness T1 of the signal enhancing heat sink). This volume and its resulting mass in combination with its specific heat capacity prevents the SERS substrate and the analyte applied to it from overheating.

In case the signal enhancing heat sink (metal body) is larger than the active area (irrespective of the thickness, that can be any as specified above) specific measures should be taken during manufacturing to prevent spillover of the nanomaterials to any area which only serves as heat sink to reduce costs. The nanomaterials are the most expensive component. To obtain a homogeneous coating, a large area rather than single droplets is coated. It is not economic, however, to coat a large area and use only a fraction of it for SERS. Alternatives would be printing techniques to restrict the coating to a small area and utilize a larger signal enhancing heat sink (FIG. 4). In this case, the heat capacity of the signal enhancing heat sink calculates to L2×W2×T2 times the specific heat capacity of its material.

The invention combines a high threshold substrate with simple, cost effective coating (e.g. drop casting). The nanoparticles may form aggregates during deposition or during solvent evaporation. For this, a cost-effective drop cast method can be used for large areas.

The invention further provides a method of spectroscopy comprising providing a substrate of the invention, depositing a sample with an analyte on the substrate's surface comprising the nanoparticles, irradiating the analyte on the substrate with light with a wavelength of 200 to 1200 nm, measuring a reflecting light from said analyte. The reflecting light is optionally and preferably scattered light, such as a Raman signal.

The analyte can e.g. be deposited in soluble form, e.g. when dissolved in a solvent. A solvent is then preferably removed before the irradiation and optical measurement. For example, an analyte may be dissolved in a solvent (water, ethanol, etc.O), deposited on the nanoparticles and then dried.

The wavelength is preferably in the ranges of 400 nm to 1200 nm, 400 nm to 600 nm, 500 nm to 700 nm, 600 nm to 800 nm, 800 nm to 1200 nm or 1000 nm to 1200 nm, such as 532 nm, 633 nm 785 nm, 830 nm or 1064 nm, or any ranges in between any of these values.

Preferably the irradiation is with light at an intensity of at least 1 kW/cm², preferably at least 1.5 kW/cm², at least 2 kW/cm², at least 2.5 kW/cm², or at least 3 kW/cm², or more, such as 3 kW/cm² to 10 kW/cm², depending on the laser average power and the spot size, which can vary between a about 2 μm to about 4000 μm, usually between 10 μm to 3000 μm, or about 50 μm to 1500 μm. The inventive substrate is suitable for such high intensity light treatments, that may cause heat in the substrate. Such heat can be removed, maintaining a low temperature increase even with high power lights sources, such as lasers. Alternatively, or in combination therewith, the irradiation can be with light (e.g. from a laser) with a power of at least 200 mW for at least 1 sec. The lights source/laser can of course be more powerful, such as a laser of at least 250 mW, or at least 300 mW, at least 400 mW, at least 500 mW; or even weaker (which may also cause heat to be dispersed by the inventive heat sink/metal body), such as a power at least 150 mw or at least 100 mW in average laser power The irradiation time may be at least 0.5 sec, at least 1 sec, at least 2 sec, at least 3 sec, at least 4 sec, at least 5 sec, at least 6 sec, at least 8 sec, at least 10 sec, at least 12 sec, at least 15 sec, at least 20 sec, at least 25 sec, at least 30 sec, or more and any range in between these values, such as 0.5 sec to 5 sec or higher, e.g. up to 30 sec or up to 20 sec (in particular longer irradiation times with weaker light sources and vice versa). An example is a light source power of about 100 mW to 400 mW and an irradiation for about 2 sec to 4 sec, e.g. using a 300 mW laser and 3 sec exposure. In case of recording several spectra for averaging, the total exposure time is up to 20 sec or longer. Thus, the total applied energy from a 100 mW laser over 10 sec amounts to 1 Ws. Possible is also an irradiation with light with a power of at least 100 mW for at least 1 sec, which amounts to an energy of at least 0.1 Ws. In preferred embodiments, the applied energy amounts to at least 0.1 Ws, preferably at least 0.2 Ws. The applied energy is the energy from the light (laser) irradiation absorbed by the substrate.

Preferably the irradiation is at an angle between a light beam and the area of the surface of at least 40°, preferably at least 60°. Steep angles, in particular at least 80° or a substantially perpendicular angle, allows high reflectivity and a collection of reflected and scattered light that did not reflect in the same direction (see FIG. 1).

Preferably a detector for reflected light is configured to receive light reflecting form said surface at an angle of at least 40°, preferably at least 60°; preferably wherein one or more optical elements like, e.g.: preferably mirrors ore optical fibers, guide (s) said light reflecting form said surface at the angle to the detector (see FIG. 1). “Configured” means that such reflected light can be directed to the detector, such as by a mirror. Alternatively, the detector may be located at said angle. In this way, it may receive the light from the surface without needing a mirror.

The inventive SERS substrate can be used to detect and characterize (quantitative and qualitative analytics) in various fields, including in biochemistry, forensics, food safety, threat detection, and medical diagnostics. Field based point of care (POC) devices potentially outperform their expensive laboratory-based counterparts in speed due to minimum sample preparation.

The substrate can be a flexible substrate. For thermal reasons, a substrate with a thickness in the order of 50 μm or less is preferred. This still allows excellent flexibility, when applied to an adhesive film.

The SERS substrate of the invention can be placed on a carrier, e.g. an adhesive film, paper, plastics, metal or glass carrier. The SERS active substrates together with an adhesive film can be placed on a carrier and optionally fixed to this carrier, e.g. by an adhesive. The carrier may be paper, plastics or glass. The carrier may have a flat or curved surface.

The adhesive SERS substrate of the invention is compatible with a 96 well plate design to support large throughput characterization. As such, a 96 well plate can be used as a carrier.

The metal body with the nanoparticles may be flexible or elastic, e.g. by using flexible material and/or thickness in which the metal body retains flexibility. The flexibility may be used to form the metal body with a curvature as mentioned above, e.g. by attaching the metal body to a carrier so that the metal body follows a curvature of the carrier.

There can also be a cover sheet, such as a cover film, on top. FIG. 9 shows a metal body (A) with a layer of nanoparticles (B) on a carrier (C) and a cover sheet (D) on top. The cover sheet may have holes or apertures to allow access to the surface with the nanoparticles for optical measurements and/or sample handling (an analyte sample may be placed on the surface for optical measurements). The cover sheet may overlap and cover a part of the surface, e.g. at its rim. This may help with fixating or solely fixating the metal body on a carrier.

The apertures may have any shape that allows access to the surface, such as e.g. round, circular or quadratic shapes.

### Basis for the Temperature Change and Heat Capacity

A body increases its temperature T to T₀+ΔT under the impact of the laser radiation from the Raman laser. The absorbed laser energy calculates to Q=P×t, with P the average power of the Raman laser and t the time of exposure. The quantitative relationship between heat transfer and temperature change contains all three factors: Q=mcΔT, where Q is the symbol for the absorbed laser energy m is the mass of the substance, and ΔT is the change in temperature. The symbol c stands for specific heat and depends on the material and phase. This formula thus gives the increase in temperature ΔT of a volume with a given mass m and a heat capacity c.

The change in temperature calculates to: ΔT=Q (1−R)/mc with the reflectivity of the SERS substrate which reduces the absorbed energy Q and whereas the final temperature T results in the following values below:

TABLE 1
Calculation of the increase of the SERS substrate's temperature in different thicknesses of the signal
enhancing heat sink under the assumption that no heat is transferred away from the SERS substrate during
the time of exposure. This calculated model does not take account of heat transfer to the environment.

| | | | | | | | Temperature | |
|---|---|---|---|---|---|---|---|---|
| Raman | | Energy at | Surface | | | mass for | increase for Al | |
| laser | exposure | Reflectivity | for 5 mm | | | Al with | with c = 0.9 | Signal enhancing |
| power | time | R = 90% | diameter | Thickness | Volume | 2.7 g/cm³ | Ws/g ° C. | heat sink |
| P (W) | t (s) | Q(Ws) | A (cm²) | d (cm) | V (cm³) | g | ΔT (° C.) | μm |
| 0.3 | 3 | 0.09 | 0.20 | 0.0018 | 0.00035 | 0.0010 | 105 | 18μ - House |
| | | | | | | | | hold Al-foil |
| 0.3 | 3 | 0.09 | 0.20 | 0.0025 | 0.00049 | 0.0013 | 75 | 25μ Professional |
| | | | | | | | | Al-foil |
| 0.3 | 3 | 0.09 | 0.20 | 0.005 | 0.00098 | 0.0026 | 38 | 50μ SERS |
| | | | | | | | | substrate |

In Table 2 below, different selection criteria for the laser are explained. Although Raman scattering is strongest at shorter wavelengths, autofluorescence can severely impede the detection (Table 2a). This is the main reason why low-cost paper substrates may not be useful. They are limited by the laser power applied in two ways. Their damage threshold is very low and the autofluorescence signal increases dramatically with the Raman laser power. Although Si detectors work very well in the VIS range, green lasers are more complex than all their longer wavelength counterparts.

A further conclusion gives a window of opportunity for a simple Si detector, paired with a direct diode Raman laser at around 785 nm, where most of the Raman systems are centered (Table 2b). This however requires a SERS substrate with a decent damage threshold, as more laser power is required than in the VIS range. Going to 1064 nm where more powerful lasers are required and available, an even higher damage threshold of the SERS substrate is required. Therefore, the invention enables effective uses in the NIR wavelength range (Table 2c).

TABLE 2a
Strong autofluorescence often cannot be outweighed by a stronger Raman
signal. Therefore, medium to long wavelengths are preferred.

| | | | |
|---|---|---|---|
| Wavelength | Short | Medium | Long |
| Positive: Raman | Strong | Medium | Weak |
| scattering | | | |
| Negative: Auto | Strong | Medium | Weak |
| fluorescence | | | |
| Best compromise | Visible (532 nm) | NIR (785 nm) | NIR (1064 nm) |

TABLE 2b
785 nm offers the unique window of using a diode laser directly
in combination with a cost-effective Si-based detector.

| | | | |
|---|---|---|---|
| Wavelength | Short | Medium | Long |
| Si based | Excellent | Good | Poor to non - |
| detector | | | requires InGaAs |
| Raman Laser | Most complex - | Most cost | Complex - diode + |
| | diode + laser + | effective: | laser |
| | conversion | Direct-diode | |
| Best choice | Visible (532 nm) | NIR (785 nm) | NIR (1064 nm) |

TABLE 2c
The invention allows the use of a powerful
laser in the NIR wavelength range.

| | | |
|---|---|---|
| Wavelength | Short | Medium to long |
| Laser Power | Low | Medium to high |
| required | | |
| Damage threshold | Low - paper based | Medium to high |
| required | SERS substrates | field of invention |
| Best choice | Visible (532 nm) | NIR (785-1064 nm) |

A high damage threshold SERS substrate for the NIR range uses a metal body as Signal enhancing heat sink with a mass that can
a. absorb the power of the Raman laser of 300 mW for >2 s (e.g. Al, 50 μm thick)
b. sustain a damage threshold of >2 kW/cm² (e.g.: 300 mW at a spot of 1/e²=200 μm)
c. prevent the analyte from overheating (e.g. limits its temperature increase to <50° C.).

### EXAMPLES

### Example 1: Manufacture of SERS Substrate

The metal base body is formed from the bottom of a disposal Aluminum cup (Al-cup, round with flat bottom, 45 ml, Ø 25-70 mm×23 mm) with the desired bottom base thickness (e.g. 50 μm-500 μm).

The Al-cup is cleaned with Alcohol 70% and Acetone P.A. Gold nanospheres (Au-NP) are provided in suspension with citrate as stabilizer (commercial product, HighQuant (Phornano), 0.8 mg/ml, diameter 40 nm, ca. 1.20E+12 NP/mL). 1 ml of the Au-NP suspension is filled into the cup to cover its flat bottom (bottom diameter, 2.5 cm; fil height ca. 2 mm). The suspension is dried for about 3 hours at 50° C. As a result, a layer of Au-NPs remains. Au-NPs form on average ca. 3-5 layers at the bottom. With higher packaging one would expect 3 layers with hexagonal packaging. This would correspond to a thickness of >100 nm at dense packaging. In FIG. 6, the packaging is random and thus the layer may be thicker at some spots. For complete removal of moisture, another 72 hours are recommended.

Next, the flat bottom is cut out and punched in 6 mm disks. Those disks are subsequently glued onto an adhesive plastic carrier and form the active SERS sensitive spots. Finally, the cover film (Polyethylene laminate) with 8 holes of 5 mm in diameter is glued on top of the transparent stripe. The distance between the centers of the holes is 9 mm, compatible with a 96 well plate.

The final product offers a plurality of active SERS sensitive disks (spots) on a flexible, adhesive carrier. On top is a cover sheet with 5 mm free aperture for each active SERS sensitive spot. This assembly is also referred to as a stripe. A cover sheet with holes smaller than the apertures to create a fixating overlap is glued on top of the stripe and defines the open aperture of the SERS sensitive spots and also secures the metal body on the carrier. Other examples for a carrier are a microscopy glass slide or a rigid or a flexible material or film, which can be adhesive on one or on both sides.

### Example 2: Increased Absorbance Towards the NIR Region

The absorbance is based upon the localized surface plasmon resonance (LSPR) of the nanoparticles. During the process of drop casting, nanoparticles form a layer and partially aggregate. This allows to extend the absorbance spectrum from a peak in the visible region towards the entire NIR region, extending the absorption from 530 nm to 785 up to 1064 nm (FIG. 5).

The generally spherical nanoparticles tend to aggregate during the drop casting process and as such form larger aggregates. As a result, the peak LSPR absorbance shifts from the visible to the NIR region and a distinct LSPR peak is modified to an entire region in which the SERS substrate is highly absorbent (FIG. 6). These results are in line with an LSPR response seen from a mixture of smaller and larger nanoparticles, as well as nanorods.

### Example 3: Damage Threshold

Damage threshold has been determined from the results using up to 373 mW of laser power and a spot size of 160 μm (1/e²). Even at maximum laser power of 373 mW, neither damage nor a hysteresis in the result was observed. It can be stated that the damage threshold is beyond the maximum power density obtained. Calculated from those values under the assumption of a Gaussian beam, an intensity of >3 kW/cm² has been reached, without any signs of damage of the SERS substrate, nor the signal due to degeneration of the analyte.

### Example 4: Thermal Properties of the SERS Substrates

TABLE 3
Measured temperature increase after laser irradiation of SERS substrate.

| | | | | | | | | Temperature | Thickness |
|---|---|---|---|---|---|---|---|---|---|
| Raman | | | | Surface | | | mass for | increase for Al | of Signal |
| laser | exposure | Laser | | for 5 mm | | | Al with | with c = 0.9 | enhancing |
| power | time | wavelength | | diameter | Thickness | Volume | 2.7 g/cm³ | Ws/g ° C. | heat sink |
| P (W) | t (s) | nm | | A (cm²) | d (cm) | V (cm³) | g | ΔT (° C.) | μm |
| 0.35 | 10*) | 785 | nm | 0.20 | 0.002 | 0.00039 | 0.0011 | 55 | 20 |
| 0.35 | 10*) | 1064 | nm | 0.20 | 0.002 | 0.00039 | 0.0011 | 42 | 20 |
| 0.35 | 10*) | 785 | nm | 0.20 | 0.004 | 0.00079 | 0.0021 | 11 | 40 |
| 0.35 | 10*) | 1064 | nm | 0.20 | 0.004 | 0.00079 | 0.0021 | 16 | 40 |

*)steady state situation: the temperature has stabilized due to equilibrium between energy applied and energy transported (convected & radiated) to the environment.

Temperature increases were measured with a thermal camera. The camera's resolution was >>100 μm and averages the temperature over this resolution size. Smaller hotter heat peaks<100 μm are possible with the comparative small heat sinks with a thickness of 20 μm when the camera registers the temperature increase of 55° C. The thicker heat sink transports the heat much better to the entire volume and better utilizes the entire surface for heat transfer, which avoids a hot spot. The thinner substrate causes a hot spot at about 70-85° C. due to low heat capacity and poor heat transfer to its periphery.

### Example 5: Analyte (Melamine) Measurements

A sample of melamine in water (10 μl, 0.5 ppm) was placed on the SERS substrate. The solvent (water) was evaporated, leaving a dry surface for Raman measurements.

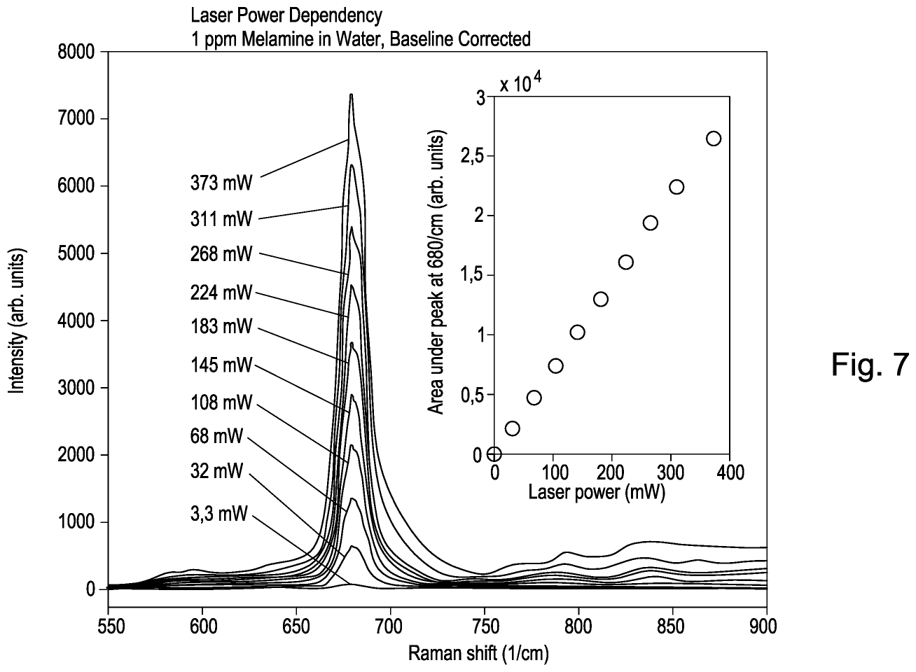

With their extraordinary high damage threshold of >3 kw/cm², the SERS substrates did not show any sign of degradation or hysteresis after multiple ramp up and down cycles of the laser power, even when full power of a >400 mW Raman laser was applied for obtaining the strongest Raman signal possible (FIG. 7).

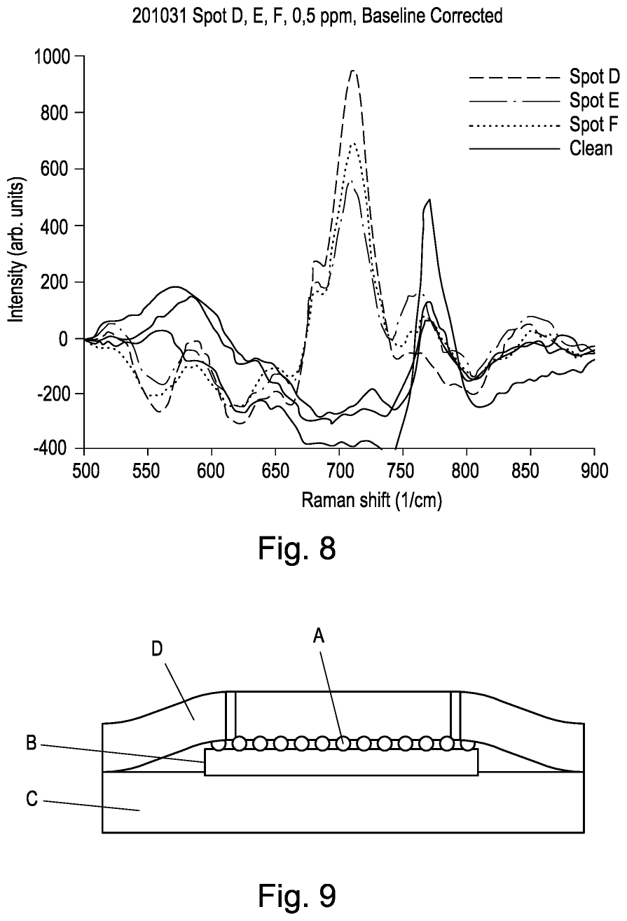

The manufactured SERS substrates significantly improved the spot-to-spot reproducibility and thus speed, cost and reliability of the measurements. FIG. 8: spot to spot deviation of the Raman signal of <12% (Spots D, E and F). For comparison, spots “clean” are background controls without melamine. The detection at 0.5 ppm Melamine in water was close to but above the limit of detection (FIG. 8).

It was observed that it is possible to increase the power of the Raman laser without damaging the SERS substrate as well as not to expose the analyte to extreme temperatures.

Throughout the present disclosure, the articles “a,” “an,” and “the” are used herein to refer to one or to more than one (i.e., to at least one) of the grammatical object of the article.

As used herein, words of approximation such as, without limitation, “about”, “substantial” or “substantially” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by e.g. +10%.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The “comprising” expressions when used on an element in combination with a numerical range of a certain value of that element means that the element is limited to that range and “comprising” relates to the optional presence of other elements. E.g. the element with a range may be subject to an implicit proviso excluding the presence of that element in an amount outside of that range. As used herein, the phrase “consisting essentially of” requires the specified integer (s) or steps as well as those that do not materially affect the character or function of the claimed invention. As used herein, the closed term “consisting” is used to indicate the presence of the recited elements only.

1. A substrate comprising: a metal body and located on a surface of said metal body a layer of nanoparticles, wherein the nanoparticles have an average diameter or size of 10 nm to 100 nm, and wherein the metal body has a thickness of at least 30 μm beneath said surface with the nanoparticles.

2. The substrate of claim 1, wherein the surface of the metal body comprises a metal oxide.

3. The substrate of claim 1, wherein the surface is a flat surface in a contiguous area of at least 1 mm² and/or lacks a nanostructured surface made of the body metal with a nanostructured surface being made by pits or peaks of a centre distance of at least 100 nm and with a depth or height respectively of at least 10 nm.

4. The substrate of claim 1, wherein at least 0.01% of the nanoparticles form aggregates or agglomerates.

5. The substrate of claim 1, wherein the nanoparticles are of a noble metal, preferably gold or silver.

6. The substrate of claim 1, wherein the metal body comprises aluminium or copper.

7. The substrate of claim 1, wherein at least 90% of the nanoparticles are located at inter-particle distances in the range of 0 nm to 100 nm.

8. The substrate of claim 1, wherein the layer of nanoparticles has a thickness of 0 to 6 nanoparticles at a surface of least 1 mm² on the metal body.

9. The substrate of claim 1, wherein the nanoparticles are Surface Enhanced Raman Spectroscopy (SERS) active.

10. The substrate of claim 1, wherein at least 0.1% of the nanoparticles are in contact with other nanoparticles.

11. The substrate of claim 1, wherein the surface comprises 100 Mio nanoparticles/mm² to 100,000 Mio nanoparticles/mm².

12. The substrate of claim 11, wherein the surface comprises 2,000 Mio nanoparticles/mm² to 10,000 Mio nanoparticles/mm².

13. The substrate of claim 1, wherein the volume above the surface is unobstructed by any part of the substrate.

14. The substrate of claim 1, wherein the substrate is flexible or elastic.

15. A method of manufacture of a substrate according to claim 1 comprising depositing a suspension of nanoparticles in a dispersion medium on a surface of a metal body, with the metal body having a thickness of at least 30 μm beneath said surface, wherein said suspension is deposited in amounts comprising 100 Mio nanoparticles/mm² to 100,000 Mio nanoparticles/mm² of the surface, and removing the dispersion medium with the nanoparticles remaining on the surface.

16. The method of claim 15, wherein the suspension of nanoparticles is deposited onto the surface of the metal body in a vessel with side walls and/or with a height of the deposited suspension of at least 0.1 mm.

17. A method of spectroscopy comprising providing a substrate of claim 1, depositing an analyte on the substrate's surface comprising the nanoparticles, irradiating the analyte on the substrate with light with a wavelength of 200 to 1200 nm, measuring a reflecting light from said analyte, preferably wherein said reflecting light is scattered light.

18. The method of claim 17, wherein the irradiation is with light at an intensity of at least 1 kW/cm², and/or the applied energy amounts to at least 0.1 Ws, and/or an irradiation with light from a laser with a power of at least 100 mW for at least 1 sec.

19. The method of claim 17, wherein the irradiation is at an angle between a light beam and the area of the surface of at least 40°.

20. The method of claim 17, wherein a detector for reflected light is configured to receive light reflecting from said surface at an angle of at least 40°, wherein one or more optical elements guide said light reflecting from said surface at the angle to the detector.
